(19) United States
(12) Patent Application Publication
(10) Pub. No.: US 2016/0063241 A1
(43) Pub. Date: Mar. 3, 2016

(54) METHOD FOR INPUTTING A SECURE PASSWORD, SHEET, SET OF SHEETS, INPUT UNIT, AND USES THEREOF

(71) Applicant: David MAUPOUX, Saint-Germain-en-Laye (FR)

(72) Inventor: David MAUPOUX, Saint-Germain-en-Laye (FR)

(21) Appl. No.: 14/778,833

(22) PCT Filed: Mar. 24, 2014
(86) PCT No.: PCT/FR2014/000064

§ 371 Date: Oct. 29, 2015

(30) Foreign Application Priority Data
Mar. 22, 2013 (FR) 1352593

(51) Int. Cl. G06F 21/46

(52) U.S. Cl. CPC G06F 21/46

(57) ABSTRACT

Method for generating and using passwords, includes:
affixing a flexible sheet having keys with patterns printed thereon to a computer device keyboard having keys with symbols imprinted thereon, the keys of the sheet overlying those of the keyboard, at least one key of the flexible sheet having a pattern overlying a keyboard key having a symbol that is different from the pattern;
inputting a first password consisting of patterns imprinted on the flexible sheet by pressing said flexible sheet thereby causing, by a mechanical effect and by the deformation of the flexible sheet at the location of said pattern, the input on said keyboard of a symbol of a different second password;
transmitting said second password from said keyboard to said computer device; and
processing the second password via the computer device itself, or via a local area network (LAN) or a wide area network (WAN).

### FIELD OF THE INVENTION

The present invention concerns a method for inputting a secure password, a sheet, set of sheets and a unit of input elements for its utilization, and the uses thereof.

The present invention thus relates more specifically to the field of computer security.

### STATE OF THE ART

Methods and systems are known, in the state of the art, that have been developed to strengthen computer security. In particular, the combination of a login and a password is used to access personal data, such as the customer account, on the majority of websites.

However, these passwords are subject to conflicting requirements:
firstly, the users must not note them down in a way that is accessible to malicious third parties, for example in computer files on their user terminal;
the users must therefore memorize them, which implies passwords that are intuitive, related to the real world, and short;
the malicious third parties searching for passwords therefore test for passwords formed from common or proper words that are easy to memorize; and
as the power of the computer systems available to malicious third parties is growing significantly, the length of the passwords must also be increased regularly.

In addition, the passwords should be changed regularly to strengthen security. But the memorization requirements described above make most of the sites and users forgo this level of security, except for passwords formed solely from digits, for example on bank sites. Because of the very fact that these are limited in number (10 digits compared to 26 letters or 36 letters and digits, not counting the other linguistic characters and the special characters and combinations of keyboard keys), their level of security is inherently limited.

In conclusion, the security of access to personal data is low and declining rapidly.

Document US 20120050005, which describes a physical non-human readable representation of a digital key on a physical key article (see abstract and claims), is known.

This system has a number of drawbacks.

In all the embodiments described, a software system is placed on the user terminal to validate the non-human readable representation of the digital key.

Because there must be a specific software system on the user terminal (see FIGS. 3 and 4), the level of security is low for all the embodiments described in this document.

This document's preamble states that the problems that may be overcome by what it describes are:
the discrimination, by the users, of the characters to be input, such as software serial numbers consisting of a string of characters (e.g. distinguishing “0” from “O”, “I” from “1”);
the use of serial numbers by the visually impaired;
data entry errors; and
spaces and hyphens, where the users are unsure whether they have to be input or not.

Therefore, this document in no way envisages the problem of transforming passwords that are long but easy to memorize into passwords that comprise no word that is easily tested for by a malicious third party.

### DESCRIPTION OF THE INVENTION

The present invention intends to remedy all or part of the inconveniences of the prior art described above.

To this end, according to a first aspect, the present invention envisages a method of generating and using passwords, characterized in that it comprises the following steps:
affixing a flexible sheet to a keyboard of a computer device, said flexible sheet comprising keys on which patterns are imprinted, and said keyboard also comprising keys on which symbols are imprinted, the keys of said flexible sheet being overlaid on the keys of said keyboard, at least one key of said flexible sheet having a pattern that is overlaid on a key of the keyboard having a symbol that is different from said pattern;
a user inputting a first password consisting of said patterns, the first password having a meaning for said user that is independent of the use thereof as a password, the input of each pattern of the first password by pressing said flexible sheet causing, through said flexible sheet, by a mechanical effect and by the deformation of the flexible sheet at the location of said pattern, the input on said keyboard of a symbol of a second password which is different from the first password and which has no meaning independent of the use thereof as password;
transmitting said second password from said keyboard to said computer device; and
processing the second password by means of said computer device itself, or via a local area network (LAN) or a wide area network (WAN).

In this way, transcribing the first password, which is understandable and therefore can be memorized by the user, into a second password, which is incomprehensible both to the user and to a third party who would like to discover it, strengthens the level of security without requiring any effort on the part of the user. Because no specific software system is required on the user terminal, no malware program such as a keylogger or Trojan horse and no remote control of this terminal can reveal the first password.

It is noted that, by regularly changing the flexible sheet, the present invention allows the second password to be regularly changed, as is recommended for computer security, while continuing to use the same first password. Similarly, with several flexible sheets it is possible to use different second passwords to access different resources, while using the same first password.

In this way, a user can have a password “for life”, which is used as a first password, for example formed from his last name, at least one first name and a date of birth, appended without spaces, e.g. “SylvieThorelJune251969”, which provides an easily remembered 22-character code, currently sufficient with regard to the computing power of the of the computer systems available to malicious third parties, even well-equipped secret services.

To further increase the security of the second password, actually used to access a resource, the distribution of patterns on the flexible sheet and each of the passwords are preferably unique for each user, and the patterns imprinted on each flexible sheet are preferably random.

In some embodiments, the method that is the subject of the present invention comprises a step of simultaneously providing:
the first password; and
said flexible sheet, each flexible sheet being different for each user so that inputting the same first password on two flexible sheets causes two different second passwords to be input.

For example, in these embodiments, a bank supplies, for accessing the account of each of its customers:
a letter or flexible card bearing the first password (for example “mybankcode”); and
a unique flexible sheet (different for each customer).

The bank's computer system memorizes the second password resulting from inputting the first password on the flexible sheet.

In some embodiments, said flexible sheet is made of a silicone elastomer, an elastomer of a different composition, plastic, fabric or paper.

In some embodiments, said patterns are imprinted on said flexible sheet by screen printing, engraving, printing, pad printing, laser or relief printing.

In some embodiments, the computer device is a computer, a mobile phone, a “Smartphone” type of device or a digital tablet.

In some embodiments, said patterns comprise at least one letter.

In some embodiments, said patterns comprise at least one digit.

In some embodiments, said patterns comprise at least one special character.

In some embodiments, said patterns comprise at least one full word, symbol, abbreviation, pictograph or drawing.

In some embodiments, said patterns are associated with at least one color.

According to a second aspect, the present invention envisages a plurality of flexible sheets, each flexible sheet of said plurality of flexible sheets comprising keys on which patterns are imprinted, the set of patterns imprinted on each flexible sheet being different from the set of patterns imprinted on any other flexible sheet in said plurality of flexible sheets.

According to a third aspect, the present invention envisages a unit for generating and using at least one password, which comprises:
a flexible sheet of the plurality of flexible sheets that is the subject of the present invention; and
a first password imprinted on a mount, said first password being intended to be input on said flexible sheet to cause, by a mechanical effect, through said flexible sheet, the input of said second password, said second password being kept in the memory of a remote computer device.

According to a fourth aspect, the present invention envisages using a flexible sheet on a keyboard of a computer device, said flexible sheet comprising keys on which patterns are imprinted, and said keyboard also comprising keys on which symbols are imprinted, the keys of said flexible sheet being overlaid on the keys of said keyboard, at least one key of said flexible sheet having a pattern that is overlaid on a key of the keyboard having a symbol that is different from said pattern, said use being via input of a first password, having a meaning that is independent of its use as a password, on said flexible sheet to cause, by a mechanical effect, the input of a second password, not having any meaning that is independent of its use as a password, on said keyboard through said flexible sheet.

These embodiments apply in particular to the distribution in stores of flexible sheets utilized in the present invention, with operating instructions dedicated to their use that is the subject of the present invention.

The advantages, aims and characteristics of the subjects of the second, third and fourth aspects of the present invention being similar to those of the method that was the subject of the first aspect, they are not repeated here.

### BRIEF DESCRIPTION OF THE FIGURES

Other advantages, aims and characteristics of the present invention will become apparent from the description that will follow, made, as an example that is in no way limiting, with reference to the drawings included in an appendix, in which:

FIG. 1 illustrates the utilization of the method according to the present invention in one embodiment;

FIG. 2 represents a standard keyboard;

FIGS. 3 to 7 illustrate examples of flexible sheets comprising patterns, in accordance with the present invention;

FIG. 8 represents, in the form of a logical diagram, steps in a first particular embodiment of the method that is the subject of the present invention;

FIG. 9 represents, in the form of a logical diagram, steps in a second particular embodiment of the method that is the subject of the present invention;

FIG. 10 represents a plurality of flexible sheets that is the subject of the present invention; and

FIG. 11 represents a unit for generating and using at least one password that is the subject of the present invention.

### DETAILED DESCRIPTION OF EMBODIMENTS OF THE INVENTION

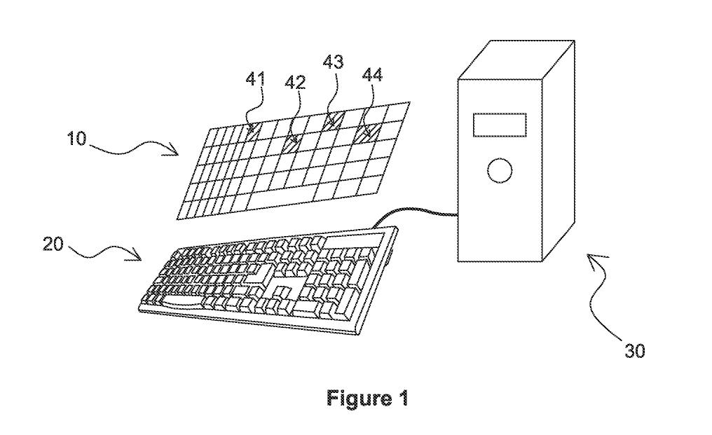

FIG. 1 illustrates the utilization of the method according to the present invention in one embodiment.

The method for generating and using passwords according to the present invention comprises the following steps:
affixing a flexible sheet 10 to a keyboard 20 of a computer device 30, said flexible sheet 10 comprising keys on which preferably random patterns 41, 42, 43, 44 are imprinted, and said keyboard 20 also comprising keys, the keys of said flexible sheet 10 being overlaid on the keys of said keyboard 20;
a user inputting a password on said keyboard 20 through said flexible sheet 10;
transmitting said password from said keyboard 20 to said computer device 30; and
processing of said password by means of said computer device 30 itself, or via a local area network (LAN) or a wide area network (WAN).

According to one embodiment, said flexible sheet 10 is made of one of the following materials: silicone elastomer, elastomer of a different composition, plastic, polymers, fabric or paper.

The flexible sheet 10 is molded or flat.

The random patterns 41, 42, 43, 44 are imprinted on the flexible sheet 10 by screen printing, engraving, printing, pad printing, laser, or relief printing, or by any other method of imprinting on said flexible sheet.

The random patterns 41, 42, 43, 44 can comprise at least one letter, at least one digit, at least one special character, at least one drawing, full word, symbol, pictograph or abbreviation, and at least one color.

The letters imprinted on said flexible sheet can be from any alphabet used in the world, in particular the following alphabets: Arabic, Armenian, Bengali, Bopomofo, braille, Coptic, Cyrillic, Devanagari, Greek, Georgian, Hangeul, Hebrew, Gojuon, Latin, Morse, Perso-arabic, Thai, Laotian, Vietnamese and Urdu.

The computer device 30 can be a desktop computer, a laptop computer, a mobile phone, a “Smartphone” type of device (touch screen or keyboard) or a touch or hybrid digital tablet (addition of a keyboard). If FIG. 1 represents a desktop computer, it is understood that the computer device 30 can also be a laptop computer, a mobile phone, a “Smartphone” type of device (touch screen or keyboard) or a touch or hybrid digital tablet (addition of a keyboard).

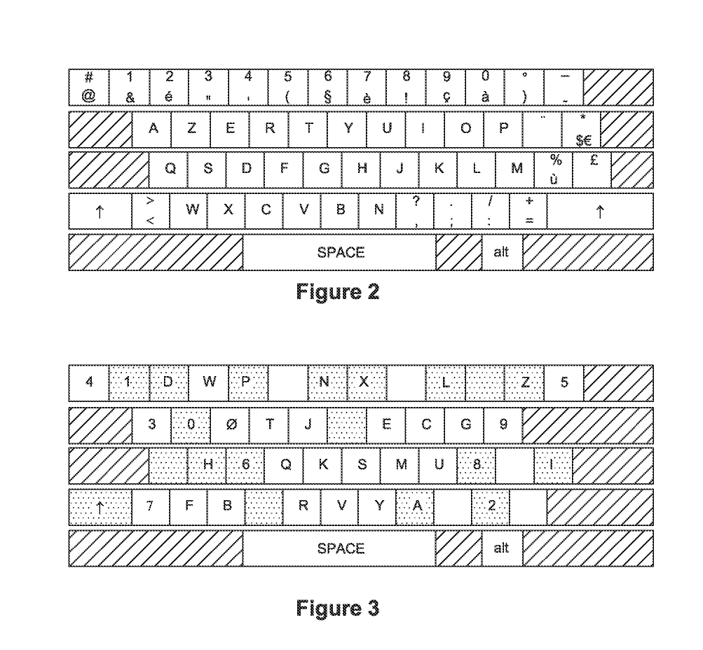

FIG. 2 represents one of the many standard keyboards that exist (the keys can differ according to the countries and brands). The computer keyboards all comply with the standards defined globally, with regard to keys, computer format, etc.

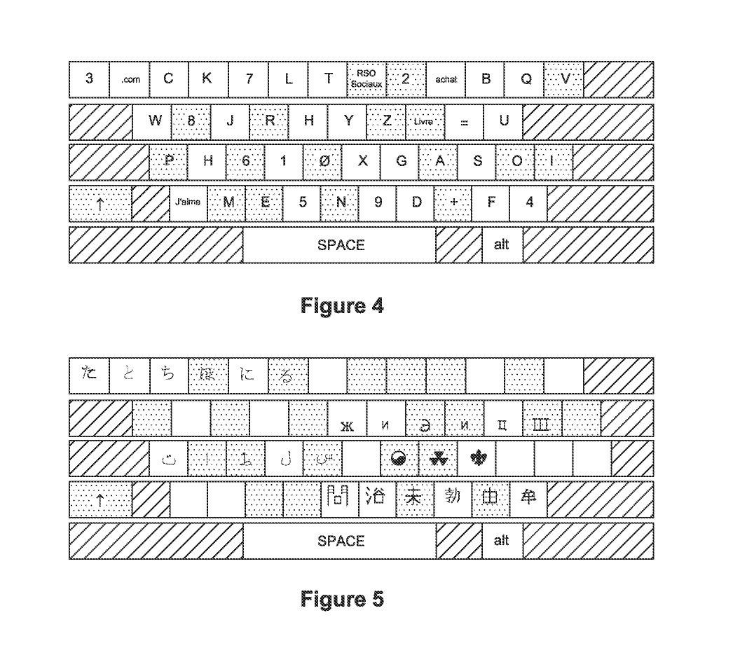

FIGS. 3, 4, 5, 6, and 7 illustrate flexible sheet examples 10 comprising patterns, in accordance with the present invention.

FIG. 3 shows such a flexible sheet 10 having random patterns 41, 42, 43, 44 in the form of digits, letters and words.

According to one embodiment, the user verifies his starting position. This must automatically be lower case. He then overlays the flexible sheet 10 on his keyboard 20, and inputs the password.

According to one embodiment, if the key is a color key, the user simultaneously presses the “Shift” key that is of the same color.

In this way, the user can input a simple code (for example Sylvie Thorel June 25 69), which is transformed into a more complex code (for example, with the flexible sheet shown in FIG. 3, “hn9b%urSZvu9/-tk%6Dp)”.

In this way, the transcription of the password in completely incomprehensible for a third party who would like to steal the password. The flexible sheet and the password generated and used are unique for each user, the patterns imprinted on each flexible sheet being random and the real password remaining in the individual's head.

FIGS. 4 and 5 illustrate other flexible sheet examples 10 comprising patterns, in accordance with the present invention.

For example, FIG. 4 comprises a “Like” key and a “Book” key.

FIG. 5 also comprises non-Latin characters, in particular characters from Cyrillic, Arabic and Asiatic languages, ideograms and pictographs.

FIG. 6 comprises words.

FIG. 7 only comprises digits.

The flexible sheet 10 can also comprise company brand names, phrases.

The method according to the present invention offers many advantages, in particular with regard to memorization and simplicity of use.

The product can be used by all users of a computing device, computer (BIOS password, system, application, Internet) from any country, of all nationalities and of all ages. The product can be adaptable for all religions, eras, sports, themes, etc.

The product can be stored in a laptop computer in transport mode, or in a desk drawer. It is easily transportable, light and can be slipped into a pocket or handbag. In addition, it is difficult to tear and is water- and wear-resistant.

Over a billion combinations are generated by the method according to the present invention.

Lastly, the method according to the present invention is of great simplicity.

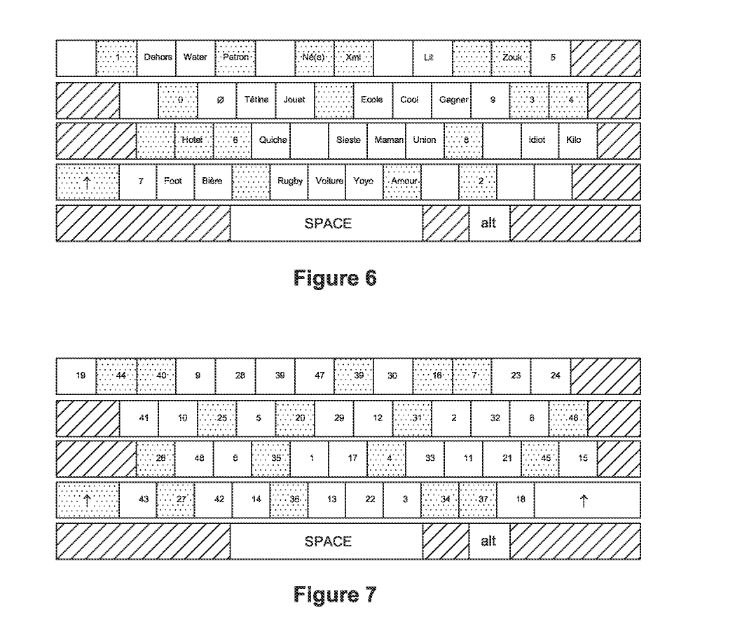

FIG. 8 shows a step 105 of associating a password (called the “first”) and a flexible sheet.

During a step 110, a second password, resulting from inputting the first password on the flexible sheet, is memorized.

Then a step 115 is carried out of simultaneously providing:
a first password; and
a flexible sheet, each flexible sheet being different for each user so that inputting the same first password on two flexible sheets causes two different second passwords to be input.

The flexible sheet comprises keys on which patterns are imprinted.

Preferably, the first password has a meaning for said user that is independent of the use thereof as a password.

Then a step 120 of affixing a flexible sheet to a keyboard of a computer device. The keyboard comprises keys on which symbols are imprinted. The keys of said flexible sheet are overlaid on the keys of the keyboard. During this step 120, at least one key of said flexible sheet has a pattern that is overlaid on a key of the keyboard having a symbol that is different from this pattern.

Then, the user carries out a step 125 of inputting the first password, consisting of said patterns. The input of each pattern of the first password by pressing the flexible sheet causes, through said flexible sheet, by a mechanical effect and by the deformation of the flexible sheet at the location of said pattern, the input on said keyboard of a symbol of a second password which is different from the first password.

Preferably, the second password has no meaning independent of the use thereof as password.

During a step 130, the keyboard transmits the second password to a computer device.

During a step 135, the computer device itself, a local area network (LAN) or a wide area network (WAN) processes the second password to validate, or not, access to a local or remote resource.

As can be seen by reading the description above, transcribing the first password, which is understandable and therefore can be memorized by the user, into a second password, which is incomprehensible both to the user and to a third party who would like to discover it, strengthens the level of security without requiring any effort on the part of the user. Because no specific software system is required on the user terminal, no malware program such as a keylogger or Trojan horse and no remote control of this terminal can reveal the first password.

It is noted that, by regularly changing the flexible sheet, the present invention allows the second password to be regularly changed, as is recommended for computer security, while continuing to use the same first password. Similarly, with several flexible sheets it is possible to use different second passwords to access different resources, while using the same first password.

In this way, a user can have a password “for life”, which is used as a first password, for example formed from his last name, at least one first name and a date of birth, appended without spaces, e.g. “SylvieThorelJune251969”, which provides an easily remembered 22-character code, currently sufficient with regard to the computing power of the of the computer systems available to malicious third parties, even well-equipped secret services.

To further increase the security of the second password, actually used to access a resource, the distribution of patterns on the flexible sheet and each of the passwords are preferably unique for each user, and the patterns imprinted on each flexible sheet are preferably random.

This embodiment applies, in particular, to the case in which a website operator supplies a password to a user of this site. During the step 115, for example, a bank supplies, for accessing the account of each of its customers:
a letter or flexible card bearing the first password (for example “mybankcode”); and
a unique flexible sheet (different for each customer).

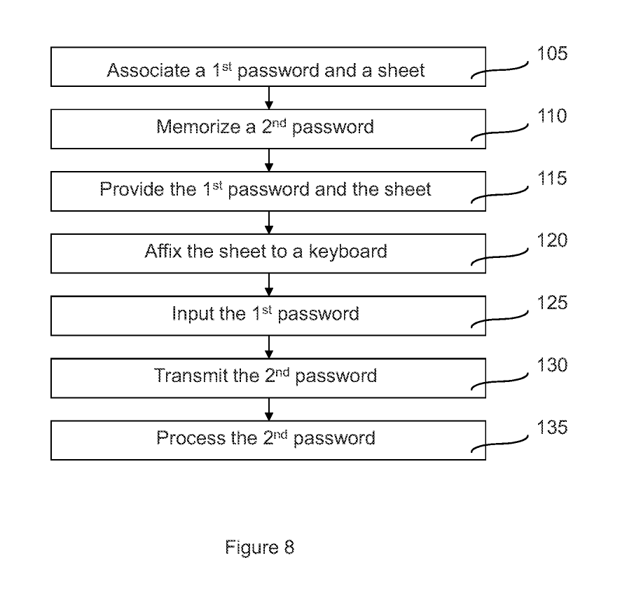

FIG. 9 shows a step 155 of a user accessing a website, with a computer device or user terminal, then a step 160 of accessing a page in this site in order to memorize a password for access to personal data. Depending on the case, the user memorizes such a password for the first time on this site, or modifies his password for this site.

Once access to the entry field for the future password (called “second”) has been obtained, the user carries out a step 165 of affixing a flexible sheet to a keyboard of a computer device, as described above.

Then, the user carries out a step 170 of inputting the first password, consisting of said patterns. The input of each pattern of the first password by pressing the flexible sheet causes, through said flexible sheet, by a mechanical effect and by the deformation of the flexible sheet at the location of said pattern, the input on said keyboard of a symbol of a second password which is different from the first password. Preferably, the second password has no meaning independent of the use thereof as password.

During a step 175, the keyboard transmits the second password to a computer device, and the computer device to the server hosting the website.

During a step 180, the server processes the second password to memorize it. Subsequently, during a step 185, this second password is used as described with reference to steps 120 to 135.

As can be seen by reading the description above, transcribing the first password, which is understandable and therefore can be memorized by the user, into a second password, which is incomprehensible both to the user and to a third party who would like to discover it, strengthens the level of security without requiring any effort on the part of the user. Because no specific software system is required on the user terminal, no malware program such as a keylogger or Trojan horse and no remote control of this terminal can reveal the first password.

It is noted that, by regularly changing the flexible sheet, the present invention allows the second password to be regularly changed, as is recommended for computer security, while continuing to use the same first password. Similarly, with several flexible sheets it is possible to use different second passwords to access different resources, while using the same first password.

In this way, a user can have a password “for life”, which is used as a first password, for example formed from his last name, at least one first name and a date of birth, appended without spaces, e.g. “SylvieThorelJune251969”, which provides an easily remembered 22-character code, currently sufficient with regard to the computing power of the of the computer systems available to malicious third parties, even well-equipped secret services.

To further increase the security of the second password, actually used to access a resource, the distribution of patterns on the flexible sheet and each of the passwords are preferably unique for each user, and the patterns imprinted on each flexible sheet are preferably random.

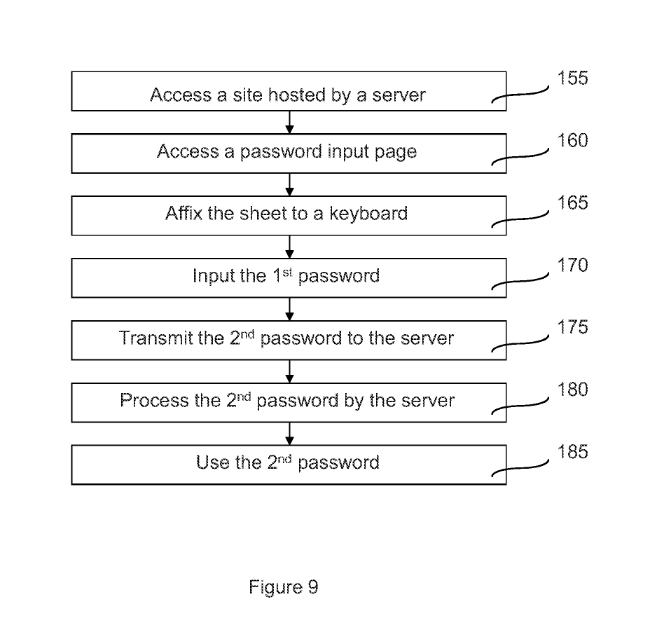

FIG. 10 shows a plurality 205 of flexible sheets 210 to 212, each flexible sheet of the plurality of flexible sheets comprises keys on which patterns are imprinted, the set of patterns imprinted on each flexible sheet being different from the set of patterns imprinted on any other flexible sheet in said plurality of flexible sheets.

Preferably, each flexible sheet 210 to 212 is associated with operating instructions 220 describing all or part of steps 155 to 185 of FIG. 9.

These embodiments apply in particular to the distribution in stores of flexible sheets utilized in the present invention, with operating instructions dedicated to their use that is the subject of the present invention.

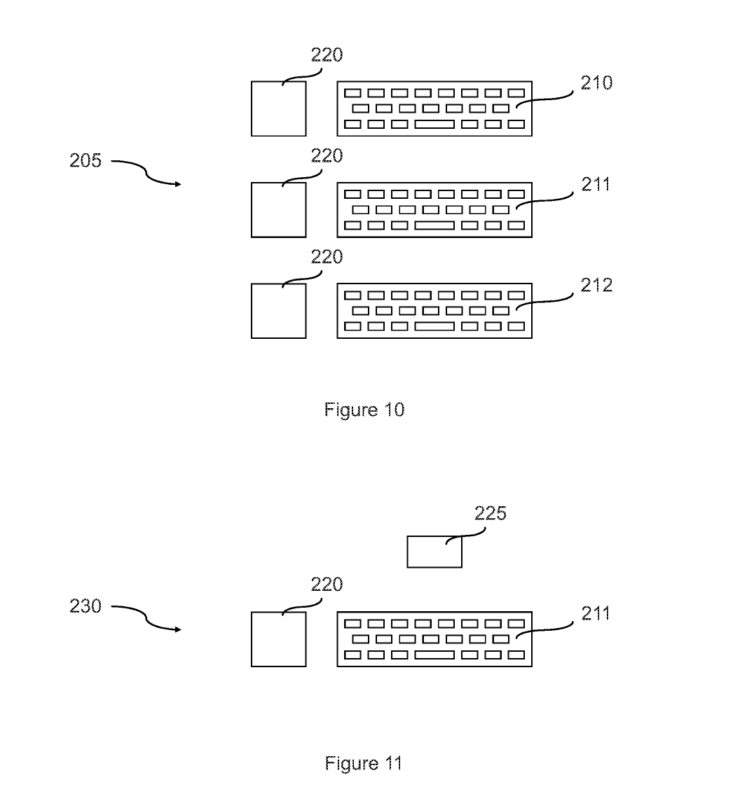

FIG. 11 shows a unit 230 for generating and using at least one password, which comprises:
a flexible sheet 211 of the plurality 205 of flexible sheets illustrated in FIG. 10; and
a first password imprinted on a mount 225, said first password being intended to be input on said flexible sheet to cause, by a mechanical effect, through said flexible sheet, the input of said second password, said second password being kept in the memory of a remote computer device.

Preferably, the flexible sheet 211 is associated with operating instructions 220 describing all or part of steps 105 to 135 of FIG. 8.

In some embodiments, some characters are duplicated on the flexible sheet but with different visual characteristics, e.g. in two different colors, one set of characters in upright characters and one set of italics. For example, only the vowels are duplicated on the flexible sheet. To use the first password and the same flexible sheet, while modifying the second password the user changes, regularly or for different utilizations, the colors of some duplicated characters. In this way he increases the security of access to his personal data. According to another example, the characters used most frequently, e.g. “a” and “e” on a French keyboard, are in more than two colors (or other visual characteristics than color) on the same sheet such that, by remembering the color associated with each site, the user supplies different second passwords on different sites (or successively for the same site) while keeping the same first password in memory.

In some embodiments, the flexible sheet is designed to correspond to several positions on the same keyboard, for example by translation. For example, the flexible sheet covers four lines of seven keys of the keyboard to represent 28 patterns representing, for example, the 26 letters of the alphabet. Thus, the same sheet can be placed in at least two different positions on the same keyboard and so, by inputting the same first password on this flexible sheet, input different second passwords. By memorizing, for each confidential resource that the user wishes to access, the flexible sheet's specific position amongst the various positions, the same first password allows different second passwords to be generated.

The invention is described above by way of example. It is understood that the person skilled in the art is able to realize different embodiments without in any way leaving the framework of the patent.

1-24. (canceled)

25. Method for generating and using passwords, that comprises the following steps:
affixing a flexible sheet to a keyboard of a computer device, said flexible sheet comprising keys on which patterns are imprinted, and said keyboard also comprising keys on which symbols are imprinted, the keys of said flexible sheet being overlaid on the keys of said keyboard, at least one key of said flexible sheet having a pattern that is overlaid on a key of the keyboard having a symbol that is different from said pattern;
a user inputting a first password consisting of patterns imprinted on said flexible sheet, the first password having a meaning for said user that is independent of the use thereof as a password, the input of each pattern of the first password by pressing said flexible sheet causing, through said flexible sheet, by a mechanical effect and by the deformation of the flexible sheet at the location of said pattern, the input on said keyboard of a symbol of a second password which is different from the first password and which has no meaning independent of the use thereof as password;
transmitting said second password from said keyboard to said computer device; and
processing the second password by means of said computer device itself, or via a local area network (LAN) or a wide area network (WAN).

26. Method according to claim 25, that further comprises a step of simultaneously providing:
the first password; and
said flexible sheet, each flexible sheet being different for each user so that inputting the same first password on two flexible sheets causes two different second passwords to be input.

27. Method according to claim 25, wherein the flexible sheet is mechanically adapted to correspond to a plurality of positions on the same keyboard, wherein, in each one of said positions, a plurality of keys of said flexible sheet are each overlaid on one and only one key of said keyboard.

28. Method according to claim 27, wherein switching from one position of the plurality of positions to another is accomplished by translation.

29. Method according to claim 25, wherein said flexible sheet is made of a silicone elastomer, an elastomer of a different composition, plastic, fabric or paper.

30. Method according to claim 25, wherein said patterns are imprinted on said flexible sheet by screen printing, engraving, printing, pad printing, laser or relief printing.

31. Method according to claim 25, wherein said computer device is a computer.

32. Method according to claim 25, wherein said computer device is a mobile phone.

33. Method according to claim 32, wherein said computer device is a smartphone type of device.

34. Method according to claim 25, wherein said computer device is a digital tablet.

35. Method according to claim 25, wherein said patterns comprise at least one letter.

36. Method according to claim 25, wherein said patterns comprise at least one digit.

37. Method according to claim 25, wherein said patterns comprise at least one special character.

38. Method according to claim 25, wherein said patterns comprise at least one full word, symbol, abbreviation, pictograph or drawing.

39. Method according to claim 25, wherein said patterns are associated with at least one color.

40. Method according to claim 25, wherein the flexible sheet comprises a plurality of the same patterns represented with different visual characteristics.

41. Method according to claim 40, wherein the different visual characteristic are different colors.

42. Plurality of flexible sheets, each flexible sheet of said plurality of flexible sheets comprising keys on which patterns are imprinted, the set of patterns imprinted on each flexible sheet being different from the set of patterns imprinted on any other flexible sheet in said plurality of flexible sheets.

43. Unit for generating and using at least one password, which comprises:
a flexible sheet of the plurality of flexible sheets according to claim 42; and
a first password imprinted on a mount, said first password being intended to be input on said flexible sheet to cause, by a mechanical effect, through said flexible sheet, the input of said second password on a keyboard of a computer device, said second password being kept in the memory of a remote computer device.

44. Unit according to claim 43, wherein the flexible sheet is mechanically adapted to correspond to a plurality of positions on the same keyboard, wherein, in each one of said positions, a plurality of keys of said flexible sheet are each overlaid on one and only one key of said keyboard.
